(19) United States
(12) Patent Application Publication
(10) Pub. No.: US 2015/0034733 A1
(43) Pub. Date: Feb. 5, 2015

(54) ASSEMBLY FOR WASHER SHOWER PIPE AND METHOD TO ADJUST OPEN AREA OF ORIFICES IN THE PIPE

(71) Applicant: Andritz Inc., Glens Falls, NY (US)

(72) Inventor: Todd S. Grace, Alpharetta, GA (US)

(21) Appl. No.: 14/339,606

(22) Filed: Jul. 24, 2014

Related U.S. Application Data
(60) Provisional application No. 61/861,713, filed on Aug. 2, 2013.

(51) Int. Cl. B05B 1/20; D21D 1/40; B05B 1/30

(52) U.S. Cl. CPC B05B 1/20; B05B 1/3026; D21D 1/40
USPC 239/11; 239/562

(57) ABSTRACT

A shower pipe assembly to provide a wash liquid for washing a pulp mat, comprising: a shower pipe with areas defining oblong orifice openings extending through the wall; and a combination plate paddle configured to be removed and configured to be adjusted along the wall, wherein the combination plate paddle comprises a plate and a paddle, wherein the plate has areas defining a plate opening as adjacent to and configured to communicate with at least one oblong orifice opening of the shower pipe in an open position, wherein the opening formed by the oblong orifice opening in the pipe and the plate can be adjusted by moving the combination plate paddle along the wall of the pipe, and the combination plate paddle is slideably engaged to the shower pipe by fasteners.

### CROSS RELATED APPLICATION

This application claims priority to and incorporates by reference U.S. Provisional App. No. 61/861,713 filed Aug. 2, 2013, the entire contents of which are incorporated herein by reference.

### BACKGROUND OF THE INVENTION

1. Technical Field

This disclosure relates generally to the field of pulp washing using a shower pipe to spray wash liquid onto a pulp mat, and particularly to the wash liquid orifice openings in the shower pipe. However, this disclosure can be related to the field of washing other materials, such as lime mud.

2. Related Art

Pulp is typically produced in mills by soaking or mixing wood pieces in tanks with chemicals. Depending on the production methods used, these chemicals are designed to have varying efficacies in converting wood pieces into pulp, and in bleaching the pulp. To obtain pulp of desired brightness and consistency, processing typically involves repeated stages of mixing the pulp with liquid and drawing the liquid out of the pulp on cylindrical vacuum drums. As pulp contacts the outer surface of the vacuum drum, liquid chemicals generally flow through holes in the outer surface of the vacuum drum, thereby allowing the semi-dry pulp to form mats on cylindrical vacuum drums. The pulp mats are generally washed by spraying or otherwise dispersing wash liquid onto the mats. Shower pipes generally span the length of the cylindrical vacuum drums and are generally located in proximity to the outer surface of the vacuum drum and the overall housing for the washing station. Wash liquid is typically used to displace chemicals from the pulp mat. The wash liquid flows through orifice openings in the shower pipes. The orifice openings are conventionally of fixed size and shape and span the length of the vacuum drums. The wash liquid flowing through the orifice openings is usually directed to the pulp mat on the vacuum drum surface by paddles mounted along the shower pipe in the vicinity of the orifice openings. Traditional paddles are stationary and cause the wash liquid to spread into a fan-shaped spray pattern.

In some conventional shower pipe arrangements, orifice openings may be in one, two, or more rows along the length of the shower pipe. Orifice openings in one row may be staggered with the openings in another row, or the openings may be circumferentially aligned, such that openings in one row are adjacently aligned with each opening in a second row along a circumferential arc of the shower pipe.

Each orifice opening typically has a paddle attached to the outside surface of the shower pipe to help direct the flow of the wash liquid exiting the orifice opening. In such arrangements, the orifice openings may be machined, drilled, or otherwise cut into the surface of the shower pipe to a predetermined size and shape. In some conventional arrangements, an orifice insert is inserted and affixed to a larger opening in the shower pipe, and this orifice insert gives the predetermined size and shape.

If the volume and intensity of the wash liquid sprayed through the orifices becomes too high, operators risk possible damage the pulp mat with the wash liquid. Conversely, operators risk insufficient washing if the volume or intensity of the wash liquid is too low.

Conventional paddles are typically welded to the pipe. When these paddles fail during the normal course of operation of the shower pipe and washer, the conventional shower pipe design can also contribute to extensive maintenance periods because removing defective paddles and re-welding new paddles to the pipe can extend downtime significantly. Operating shower pipes with damaged but still operational paddles contributes to inefficient washing.

Other conventional shower pipes may use a spray nozzle attached to the shower pipe (as described in U.S. Pat. No. 7,708,207, the entirety of which is incorporated herein by reference). In the spray nozzle configuration, nozzles generally extend the length of the shower pipe and are typically configured to spray a wash liquid onto the pulp mat. The shower pipe usually spans the length of the pulp mat and the nozzles may be laterally aligned into two or more rows such that immediately adjacent apertures are in different rows. The wash liquid usually flows through the shower pipe, into the hollow stem of the nozzle, and out of the nozzle in a stream toward the pulp mat. The nozzles typically spread the stream such that the wash liquid is sprayed uniformly onto the mat. These nozzles sometimes eliminate the need for paddles to direct the flow of wash liquid. The spray nozzles, however, have a tendency to become plugged, which may result in uneven distribution of wash liquid along the surface of the pulp mat. The spray nozzles may be attached individually to the shower pipe, and replacement may be possible, but adjusting the size or shape of the spray nozzle opening is not possible without replacement of the spray nozzle. Each of either the multiple rows of apertures or the nozzle configurations generally project wash liquid toward the mat at different directions.

### BRIEF SUMMARY OF INVENTION

In conventional shower pipes, the open area for wash liquid is fixed. For conventional shower pipes with orifices, the open area of each orifice is constant. Similarly, conventional spray nozzles have fixed openings for wash liquid. Changing the open area requires metal work to change the size of the orifice or to replace a nozzle. Fixed sized openings or nozzles can result in uneven washing of the pulp mat or damage to the pulp mat. Uneven washing of the pulp mat can be especially problematic when the volume or intensity of wash liquid through a single or group of orifice openings or nozzles unintentionally changes. Further, conventional shower pipes do not allow for flexibility to remove and replace the mechanism used to direct wash liquid flow from the shower pipe to the pulp mat surface. Controlling the volume and intensity of wash liquid flow may be desirable to improve washing of the pulp mat. Moreover, controlling the volume and intensity of the wash liquid flow may facilitate removing and replacing the mechanism used to direct the wash liquid flow, especially when individual mechanisms used to direct the wash liquid flow become damaged. Accordingly, there is a need for a shower pipe with adjustable wash liquid flow opening size and shape having easily removable flow direction mechanisms to provide improved control of wash liquid volume, intensity, and flow direction. The present disclosure may be suitable for use in processes where wash liquid is desirably uniformly distributed over a width of material, such as a pulp mat, to remove chemicals from the pulp. The problems of conventional shower pipes are solved through the use of adjustable open areas and adjustable paddles to control and direct the flow and distribution of wash liquid onto a pulp mat.

A shower pipe assembly has been conceived to provide wash liquid for washing a pulp mat, the shower pipe containing oblong orifice openings in the shower pipe outside wall; the term “oblong” may refer to a stadium shape resembling the general shape of a horse race track.

An exemplary embodiment comprises a shower pipe assembly to provide a wash liquid for washing a pulp mat, the assembly comprising: a shower pipe with areas defining oblong orifice openings extending through the wall of the shower pipe, the wall having an inside and an outside; and a combination plate paddle configured to be removed and configured to be adjusted along the outside wall of the shower pipe, wherein the combination plate paddle may comprise a plate and a paddle, wherein the plate may be configured to be attached to the wall of the shower pipe and the paddle may be configured to distribute wash liquid exiting the shower pipe oblong orifice openings to the pulp mat, the paddle may extend from a lower edge of the plate outward from the surface of the shower pipe, wherein the plate may have areas defining a plate opening adjacent to and configured to communicate with at least one oblong orifice opening of the shower pipe in an open position, and the combination plate paddle may be slideably engaged to the shower pipe by fastening means.

The fastening means may comprise bolts, rails, grips, lips, flanges, buckles, magnets, screws, or other means than permit the combination plate paddle to move in a first direction and a direction opposite to a first direction along a plane.

In another exemplary embodiment, the combination plate paddle can be unbolted and slid axially (e.g. horizontally) to adjust the open space size and shape through which the wash liquid may flow from the shower pipe. By unbolting and sliding axially the combination plate paddle, the size and shape of the open space in the shower pipe can be adjusted to be full size (the size of the oblong orifice opening of the shower pipe) or a size smaller than the oblong orifice opening of the shower pipe, thereby allowing the open space through which wash liquid flows from the shower pipe to be adjusted to a desirable size and shape. Such an adjustable shower pipe assembly may allow for adjustable open space for the flow of wash liquid from the shower pipe resulting in better control of the volume and intensity of wash liquid flowing to wash the pulp mat, increased accessibility for maintenance of the oblong orifice openings in the shower pipe, an increased ability to maintain or replace the combination bolt plate paddle on the shower pipes, an ability to vary the size of the open space for wash liquid flow along the shower pipe length, and reduced potential for plugging the orifice opening due to the lack of a spray nozzle.

The combination plate paddle may be held in place by a fastener, such as at least one bolt passing through the plate, the plate having at least one slotted opening to allow the at least one bolt to pass and allow the plate to be moved slideably to adjust the shape and size of the open space through which the wash liquid passes from the shower pipe. The combination plate paddle may be a single structure with a plate configured to be attached snugly to the surface of the shower pipe and a paddle extending from the lower edge of the plate outward from the surface of the shower pipe. Wash liquid can pass through the oblong orifice opening of the shower pipe and through the open area resulting from the placement of the combination plate paddle on the shower pipe and contacting the paddle. The paddle can serve to spread the wash liquid as the wash liquid exits the open area resulting from the placement of the combination plate paddle on a shower pipe's oblong orifice opening toward the pulp mat such that the wash liquid contacts the pulp mat in a desired manner, which is usually a uniform pattern. The plate may be held in place by one or more bolts, but desirably two bolts disposed in slotted openings disposed opposite the plate opening. A slotted opening or openings may be an oblong shape or other suitable shape in the plate, positioned generally to the side (one side or both sides) of the plate opening through which the wash liquid flows. The plate opening may have a geometric shape selected from the group consisting of a rounded trapezoid, rounded triangle, triangle, trapezoid, circle, oval, oblong, or other geometric shape. The bolts in the slotted openings generally allow the plate to slide axially along the outer wall of the shower pipe surface in front of the shower pipe's oblong orifice openings thereby permitting the adjustment of the size and shape of the open space through which wash liquid flows out of the shower pipe assembly.

In other embodiments, the slotted openings may be oriented vertically on the plate such that the plate may move tangentially relative to the circumference of the shower pipe. Desirably, in yet another exemplary embodiment, the slotted openings may be oriented generally vertically such that the combination plate paddle may be flush with the curvature of the outside wall of the shower pipe and move circumferentially along a circumferential arc on the outside wall of the shower pipe. In the exemplary embodiment in which the combination plate paddle moves circumferentially along the outside wall of the shower pipe, the shower pipe may rotate along the shower pipe's center horizontal axis such that combination plate paddle may be angled toward the pulp mat at an optimal angle between 0 degrees and 90 degrees and the open area of the orifice opening and plate opening may be adjusted such that wash liquid may contact the paddle of the combination plate paddle at optimal intensity.

In at least one exemplary embodiment, the shower pipe may be hollow and wash liquid may be fed into the shower pipe from at least one end. In certain exemplary embodiments, the plate and the paddle may form a single combination plate structure.

An additional exemplary embodiment of the shower pipe assembly allows the bolt piece, and therefore the combination bolt plate paddle, to slide along the outer surface of the shower pipe thereby providing positions for the shape and size of the open space through which wash liquid flows from the shower pipe.

In the present disclosure, the combined bolt plate paddle structure may be shaped to fit securely to the outer surface of the shower pipe and a paddle, or combination bolt plate paddle, may be provided for each shower pipe orifice opening.

In other exemplary embodiments of the disclosure, the orifice openings of the shower pipe can extend the length of the shower pipe and may be positioned in at least two parallel rows where adjacent orifice openings can be staggered so the orifice openings do not generally align circumferentially and can be located in different rows.

An exemplary method to adjust the open space of a shower pipe assembly has been conceived comprising: having a shower pipe having and inner and outer surface and having areas defining oblong orifice openings positioned along a length of the pipe in at least one parallel row to allow the flow of wash liquid from the shower pipe out of the orifice openings for washing of a pulp mat; attaching a plate and paddle to the outer surface of the shower pipe, the plate and paddle configured to be removed; wherein, the plate has areas defining a rounded triangular opening disposed adjacent to each oblong orifice opening of the shower pipe; and sliding the plate circumferentially along the outer surface of the shower pipe such that an open area defined by the adjacent plate opening and each oblong orifice opening and having a size and a shape, is configured to be adjusted in size and shape; wherein, the plate having at least one slotted opening further comprises at least one bolt passing through the at least one slotted opening to secure the plate to the shower pipe.

### BRIEF DESCRIPTION OF THE DRAWINGS

The foregoing will be apparent from the following more particular description of exemplary embodiments of the disclosure, as illustrated in the accompanying drawings in which like reference characters refer to the same parts throughout the different views. The drawings are not necessarily to scale, with emphasis instead being placed upon illustrating the disclosed embodiments.

FIG. 1 is a close-up of a side view of a conventional shower pipe assembly with fixed orifice openings and attached paddles.

FIG. 2 is a side view of the full length of a conventional shower pipe assembly with fixed orifice openings and attached paddles in two parallel rows.

FIG. 3 is a close-up of a side view of an exemplary embodiment of a shower pipe, plate, and paddle with a one bolt attachment.

FIG. 4 is a top-down view of an exemplary combination plate paddle having an oblong plate opening before the combination plate paddle is shaped and attached to a shower pipe.

FIG. 5 and FIG. 6 show an exemplary embodiment of a combination plate paddle on a shower pipe, wherein FIG. 5 shows an exemplary combination plate paddle positioned to a fully open position with respect to the orifice opening in the shower pipe; and FIG. 6 shows an exemplary combination plate paddle positioned to fully closed position.

FIG. 7 shows a cross-section of an exemplary embodiment of a shower pipe, paddle, and bolt, and a cross-section of a portion of a cylindrical drum, such as a vacuum drum dryer for pulp drying.

FIG. 8 is a front view of an exemplary shower pipe assembly comprising a combination plate paddle having a rounded triangular plate opening.

FIG. 9 is a top-down view of an exemplary embodiment of a combination plate paddle having a rounded triangular plate opening before the combination plate paddle is shaped and attached to a shower pipe.

FIG. 10 shows an exemplary shower pipe assembly having a plate in a fully open position and a plate in a partially closed position.

FIGS. 11 and 12 show a cross-section through an axis of an exemplary embodiment of a shower pipe, paddle, bolt, and a cross-section of a portion of a cylindrical drum, such as a vacuum drum dryer for pulp drying.

### DETAILED DESCRIPTION OF THE PREFERRED EMBODIMENTS

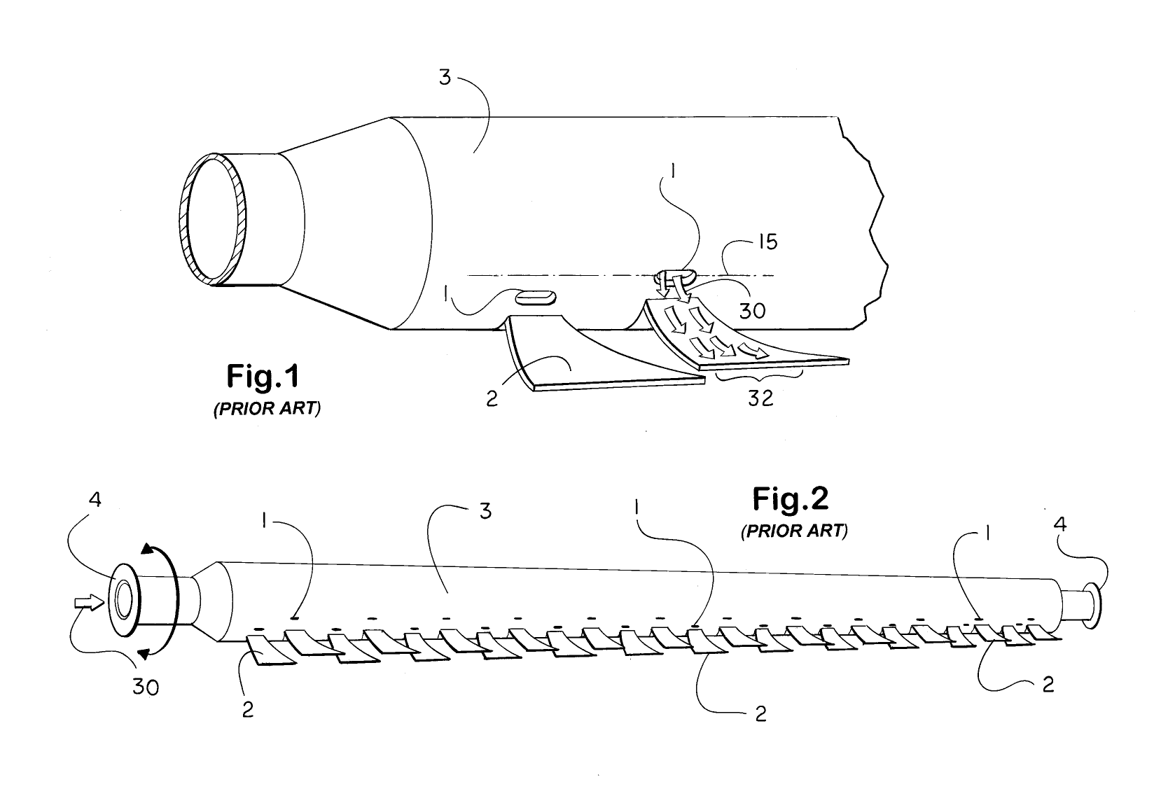

FIGS. 1 and 2 depict views of a conventional shower pipe assembly in which orifice openings 1 are drilled, cut, or otherwise formed in a cylindrical wall of a hollow shower pipe 3. The shower pipe 3 provides a conduit that distributes the wash liquid 30 to the orifice openings 1. Wash liquid 30 flows through the orifice openings 1 as the liquid is sprayed onto a pulp mat on a rotating drum or other device.

As the wash liquid 30 flows from each orifice opening 1, the liquid flows onto a conventional paddle 2 attached to the outer surface of the shower pipe 3. The conventional paddle 2 may be adjacent the orifice opening 1 but does not block or overlap the orifice opening 1. As wash liquid 30 hits the conventional paddle 2, the conventional paddle 2 helps to create a wide stream 32 of wash liquid 30, as the conventional paddle 2 directs the wash liquid 30 toward the pulp mat.

The orifice openings 1 may be arranged in one or more rows parallel to a center horizontal axis 15 of the shower pipe 3. If there are multiple rows, the rows may be positioned in at least one or more parallel rows where adjacent orifice openings 1 are staggered such that the orifice openings 1 do not align circumferentially. The adjacent orifice openings 1 may be located in different rows. Typically, as shown in FIG. 2, the orifice openings are equally spaced along the lateral direction of the shower pipe 3.

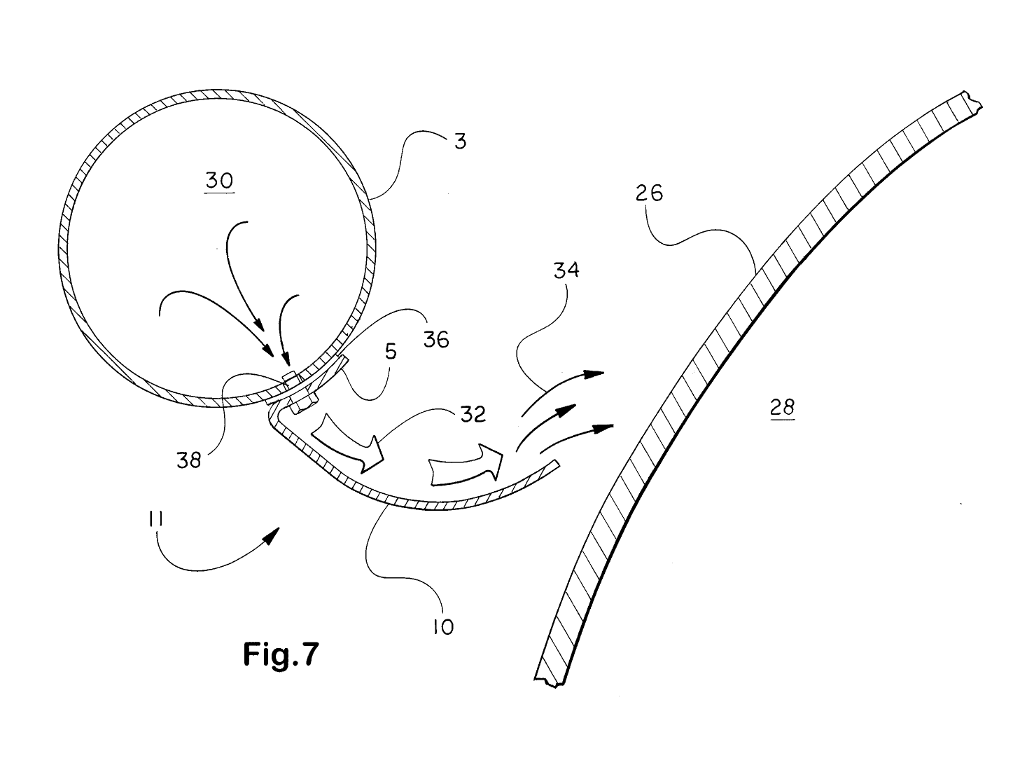

The shower pipe 3 includes a connection 4 at one or both ends of the shower pipe 3 and the shower pipe 3 may rotate in the direction of the double arrows depicted in FIG. 2. The connection 4 connects to a source of wash liquid (not depicted). Water may be an exemplary wash liquid. The wash liquid 30 may enter the connection 4 and flow through the interior conduit of the shower pipe 3. The wash liquid 30 may flow through the orifice openings 1 and may be spread by the paddles 2 into a wide stream. The arrangement of orifice openings 1 and paddles 2 may form overlapping or adjacent streams that evenly and uniformly spray the pulp mat (26 in FIG. 7) with wash liquid 30.

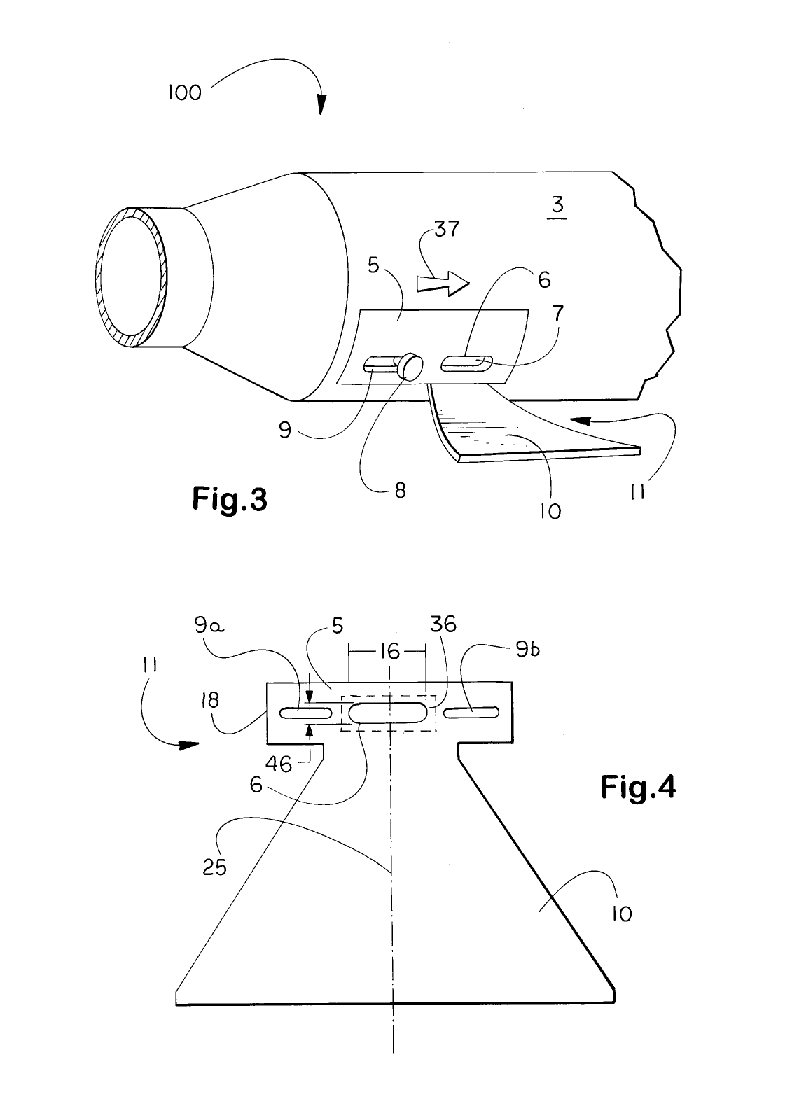

Referring now to FIG. 3 (similar parts are identified by similar numbers in all figures), an illustrative embodiment of the shower pipe assembly 100 to provide a wash liquid 30 for washing a pulp mat (see 26 in FIG. 7) is shown. The combination plate paddle 11 includes a plate 5 that is disposed on the outer wall of the shower pipe 3 and a paddle 10 (shown here as attached to the plate 5). The plate 5 may be integral with the paddle 10 or separate from the paddle 10. The plate 5 may be secured to the outside wall of the shower pipe 3 by one or more bolts. The plate 5 is generally secured over one of the orifice openings 1 in the shower pipe 3.

The plate 5 serves as a valve to open or close the orifice opening 1 in the shower pipe 3. The plate 5 includes an area defining a plate opening 6 that may have a similar open area 7 and shape as does the orifice opening 1. It will be understood that the “open area” 7 refers to the area created by the orifice opening 1 communicating with the plate opening 6. The orifice opening 1 and the plate opening 6 may have corresponding open areas 7 having a shape of an oblong, racetrack, rectangular, elliptical, circular, or other shape. In other exemplary embodiments, the area defining the plate opening 6 in the plate 5 may differ from the shape of the orifice opening 1. For example, the plate opening 6 may have a trapezoidal, rounded trapezoidal, triangular, rounded triangular, hexagonal, rounded hexagonal, or other polygonal or rounded polygonal shape.

The amount of overlap between the plate opening 6 in the plate 5 and the orifice opening 1 in the shower pipe 3 determines the open area 7 through which wash liquid 30 flows from the shower pipe 3 to the pulp mat (26 in FIG. 7). The plate 5 is mounted to the shower pipe 3 such that the amount of overlap between the plate opening 6 and orifice opening 1 can be adjusted. The plate 5 may be moved by sliding the plate 5 in a lateral direction 37 parallel to the axis of the shower pipe 3. The plate 5 may be securely fixed to the shower pipe 3 by a bolt 8. The bolt 8 extends through a slot 9 in the plate 5 and engages a threaded bolt hole (38 in FIG. 7) in the wall of the shower pipe 3. When the bolt 8 is tightened in the threaded bolt hole (38 in FIG. 7) in the wall of the shower pipe 3, the plate 5 is held securely against the outside wall of the shower pipe 3 and the plate 5 cannot move.

It will be understood that the modifications of FIGS. 3 through 12 and 10 could be employed in combination with one another as well as individually in the assemblies of FIGS. 3, 5 to 8, and 10 to 12.

FIG. 3 shows a single bolt 8 holding the plate 5 to the shower pipe 3; however two or more bolts may be used as shown in FIG. 4. The curvature of the plate 5 can match the curvature of the shower pipe 3. The matching curved plate 5 and shower pipe 3 assist the bolt 8 in preventing rotation of the plate 5 about the shower pipe 3.

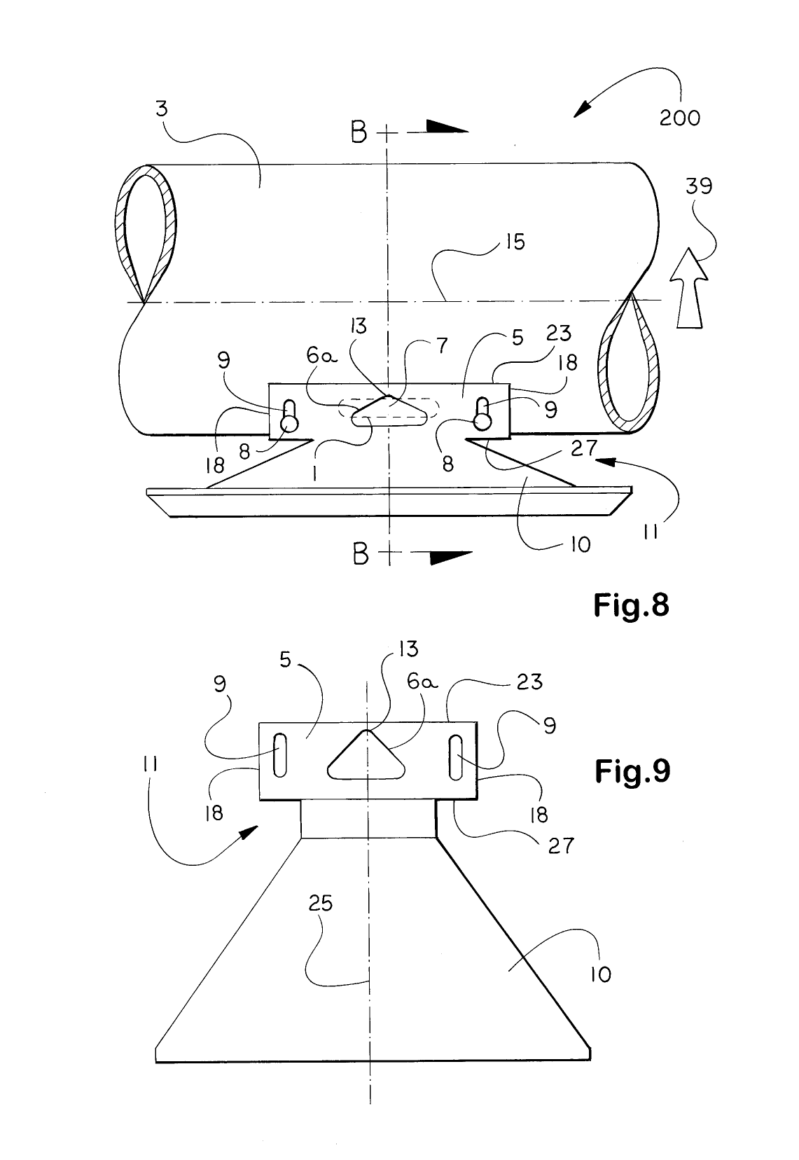

The plate 5 may be adjusted by loosening the bolt 8. The plate 5 slides axially to adjust the overlap between the plate opening 6 in the plate 5 and the orifice opening 1 in the shower pipe 3. The overlap is adjusted to change the open area (7 in FIG. 8) through which wash liquid 30 flows from the shower pipe 3 and therefore the amount of wash liquid 30 desired to flow from the open area formed by the plate opening 6 of the plate 5 sliding over the orifice opening 1 of the shower pipe 3. The overlap may be adjusted if there is too much or to little water impinging on a section of the pulp mat. Each plate 5 adjusts the wash liquid 30 flow from its corresponding orifice openings 1 on the shower pipe 3. Thus, the plate 5 provides a means for individually adjusting each stream of wash liquid 30 flowing from the shower pipe 3.

FIG. 4 is a front view of another exemplary embodiment of a combination plate paddle 11. The combination plate paddle 11 may be formed, e.g. stamped, from a planar sheet of metal and can be comprised of a plate 5 and a paddle 10. The plate 5 includes a plate opening 6 that may have a lateral dimension 16 greater than the width 46 of the orifice opening 1 of the shower pipe 3 (see FIG. 1). In other exemplary embodiments, the plate opening 6 may correspond to the size and shape of the orifice opening 1 in the shower pipe 3 to which the plate 5 attaches, thus overlapping orifice opening 1 of the shower pipe 3. The plate 5 has slots 9a and 9b to receive the shaft of a bolt (such as bolt 8 shown in FIG. 3). The slots 9a and 9b may have a similar shape and size, and each is on opposite sides of the plate opening 6. Providing two slots 9a and 9b prevents rotation of the combination plate paddle 11 about the shower pipe 3.

The plate 5 may be asymmetrical with respect to a center line 25 of the combination plate paddle 11. The center line 25 extends through the center of the plate opening 6 and the center of the paddle 10. An asymmetrical combination plate paddle 11 positions one of the slots 9b laterally further away from the plate opening 6 than the other slot 9a.

A gasket 36 may fit between the back of the combination plate paddle 11 and outside wall of the shower pipe 3. The gasket 36 may be generally planar and conform to the curvature of the combination plate paddle 11. The gasket 36 may extend around the plate opening 6 in the combination plate paddle 11 and be between the plate opening 6 and the slots 9a and 9b. The gasket 36 is desirably deformable and provides a seal to prevent leakage of wash liquid 30 out from edges 18, (23, 27 in FIG. 8) of the plate 5.

A curvature may be applied to the combination plate paddle 11 to conform to the outer surface of the shower pipe 3. An angle and curvature may be applied to the paddle 10 to achieve a desired wide stream to the wash liquid 30 flowing over the paddle 10.

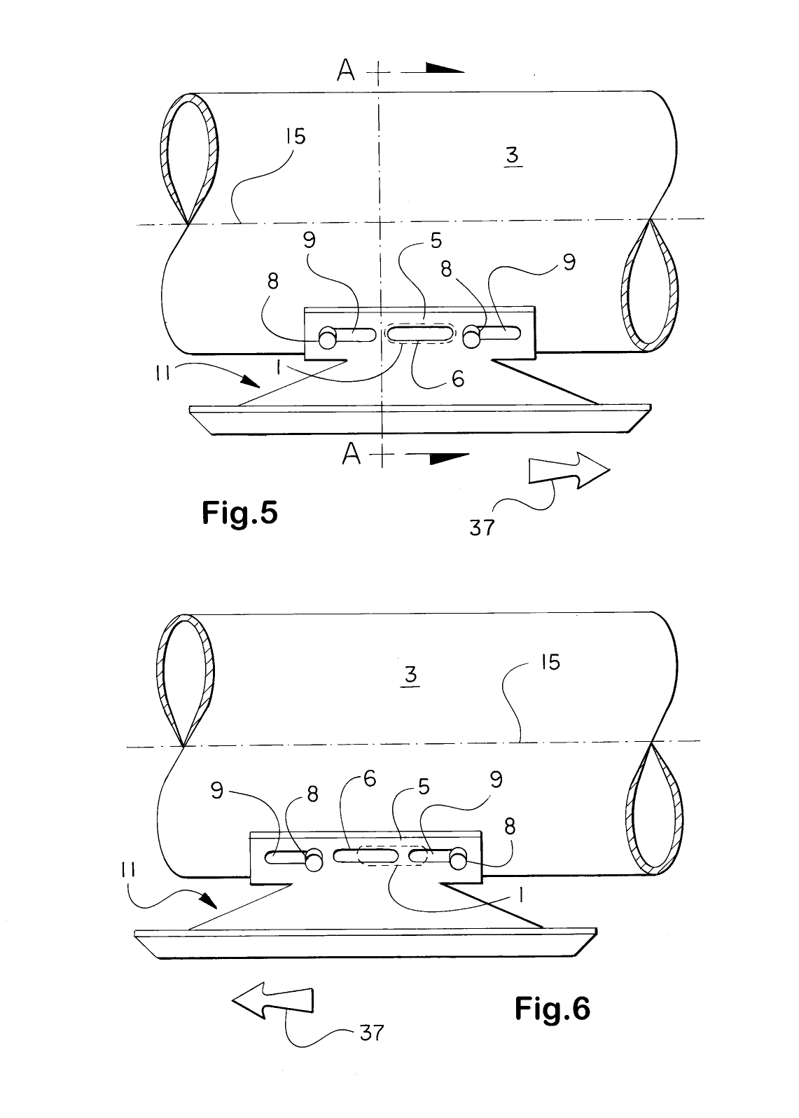

FIGS. 5 and 6 show the combination plate paddle attached to the shower pipe 3 such that the plate 5 overlaps one of the orifice openings 1 (shown in FIG. 1) in the shower pipe 3. FIG. 5 shows the combination plate paddle 11 slid such that the plate opening 6 is coextensive with the orifice opening 1 in the shower pipe 3. Wash liquid 30 may flow from the orifice opening 1 and is not obstructed by the combination plate paddle 11. The wash liquid 30 flows from the orifice opening 1 and onto the paddle 10 of the combination plate paddle 11. The paddle 10 is angled and curved to spread and direct the stream of wash liquid 30 toward a pulp mat (26 in FIG. 7).

Bolts 8 engaged with threaded bolt holes (38 in FIG. 7) in the shower pipe are loosened to slide the combination plate paddle 11 from the fully open position as shown in FIG. 5 to a fully closed position as shown in FIG. 6. The combination bolt plate paddle 11 may be slid to increase or decrease the amount of overlap between the plate opening 6 in the plate 5 and the orifice opening 1 in the shower pipe 3 (see FIG. 1). The overlap may be adjusted by sliding the combination plate paddle 11 at any point along the slots 9, which engage the bolts 8. By adjusting the amount of overlap, operators may increase or decrease the open area through which the wash liquid 30 flows. In certain exemplary embodiments, the open area for the wash liquid 30 need not be fully open or fully closed (as shown in FIGS. 5 and 6), and can be selected to be an amount of open space between fully open and closed by sliding the plate 5. Once the plate 5 has been positioned to provide the desired area space for the wash liquid 30, the bolts 8 are tightened to bind the combination plate paddle 11 against the outside wall of the shower pipe 3.

FIG. 7 is a cross-sectional view of an exemplary shower pipe assembly 100 of FIG. 5 along the line A-A. The cross-sectional view of FIG. 7 depicts an exemplary combination plate paddle 11 and a pulp mat 26 on an outer surface of a rotating drum 28. Wash liquid 30, e.g., water, can flow from the shower pipe 3, through the open area formed by the overlapping of orifice opening 1 (see FIG. 1) in the shower pipe 3 and plate opening 6 (see FIGS. 4, 5, and 6). The wash liquid 30 is spread into a wide stream 32 by the paddle 10 of the combination plate paddle 11. The wide stream 32 may become a spray 34 as the wide stream 32 leaves the paddle 10 to become deposited on the pulp mat 26 to wash pulp on the mat.

The combination bolt plate paddle 11 can be secured to the shower pipe 3 by one or more bolts 8 that screws into an area defining a threaded bolt hole 38 in the wall of the shower pipe 3. A gasket 36 may be placed between the outside wall of the shower pipe 3 and the plate 5. The gasket 36 may extend around the plate opening 6 in the plate 5. The gasket 36 may be deformable and provide a seal to prevent wash liquid 30 leaking through the slots 9 in the plate 5 and from between the combination plate paddle 11 and shower pipe 3.

FIG. 8 is a front view of an exemplary shower plate assembly 200 comprising a combination plate paddle 11 having a rounded triangular plate opening 6a. Bolts 8 may slideably engage the combination plate paddle 11 to the outer wall of the shower pipe 3. The shower pipe 3 includes a plurality of oblong orifice openings 1 extending through the wall of the shower pipe 3. By adjusting the rounded triangular plate opening 6a relative to the oblong orifice opening 1, operators may change the open area 7 through which wash liquid 30 may exit the interior of the shower pipe 3. The mutable shape of the open area 7 allows operators to adjust the rate and intensity at which wash liquid 30 contacts the paddle. The mutable shape of the open area 7 may affect the distribution of wash liquid 30 as the wash liquid 30 contacts the paddle 10, thereby affecting the distribution of the characteristics and distribution of wash liquid 30 in the wide stream 32 formed by the paddle 10.

FIG. 9 is an illustrative depiction of a combination plate paddle 11 before the combination plate paddle 11 is pressed and rolled to be configured to attach to the shower pipe 3 and shape the paddle 10. In exemplary embodiments, the plate opening 6 may be rounded triangular plate opening 6a. In certain embodiments, the narrow side of the rounded triangle may be oriented proximate the upper edge 23 of the plate 5. In another exemplary embodiment, the narrow side 13 of the rounded triangular plate opening 6a may be oriented proximate the lower edge of the plate 5. The slots 9 are vertically oriented relative to the side edges 18 of the plate 5. Bolts (8 in FIGS. 3, 5, and 6) may secure the combination plate paddle to the shower pipe 3 through the slots 9.

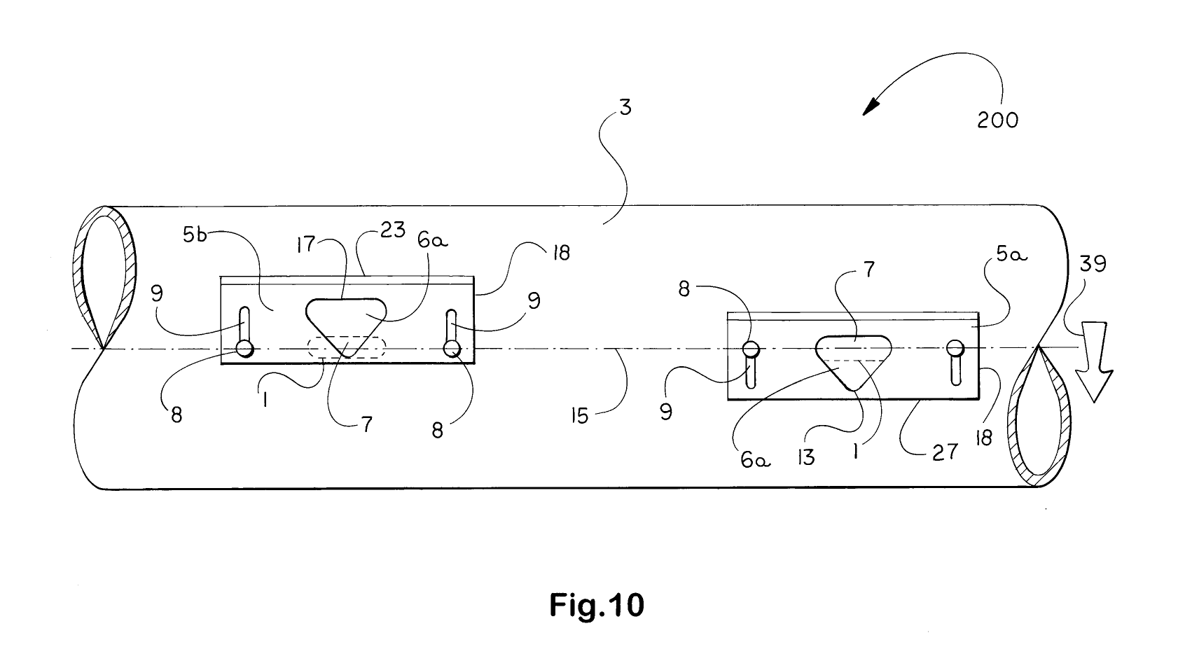

FIG. 10 shows an exemplary shower pipe assembly 200 having a plate 5a in a fully open position and a plate 5b in a partially closed position. In other exemplary embodiments, the plates 5 may be adjusted to a fully closed position (see FIG. 6). In the fully open position, the open area (7 in FIG. 8) may be substantially oblong. The oblong shape of the open area 7 tends to equalize the rate at which wash liquid exits the shower pipe 3 and may facilitate even distribution of wash liquid 30 onto the paddle 10. In the partially closed position, operators may change the shape of the open area 7 and increase the rate and intensity at which wash liquid 30 contacts the paddle while simultaneously adjusting the position of the paddle relative to the shower pipe 3.

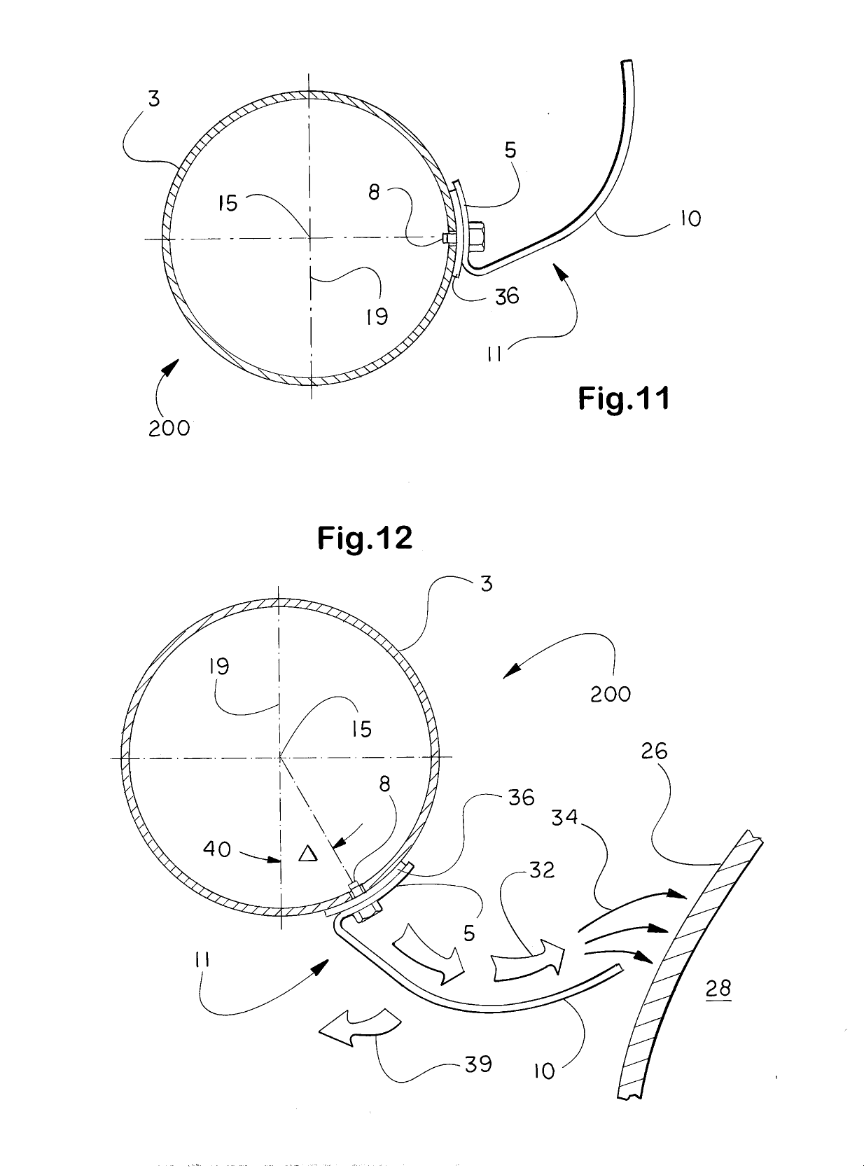

FIG. 11 is a cross-sectional view of the exemplary shower pipe assembly 200 in FIG. 8 along the line B-B. The shower pipe 3 may be rotated along center horizontal axis 15 and may be positioned at an angle delta (Δ) relative to a shower pipe vertical axis 19.

FIG. 12 depicts the cross section of FIG. 11 with the shower pipe 3 at angle Δ. Adjusting the combination plate paddle 11 in a vertical manner changes the position of the paddle 10 relative to the pulp mat 26. By adjusting the angle Δ of the shower pipe in an annular direction 40 and by adjusting the open area 7 by sliding the combination plate paddle 11 vertically, operators may control the rate at which wash liquid 30 contacts the paddle 10, the distribution and flow characteristics of the wash liquid 30 as the wash liquid 30 becomes a wide stream 32, and the angle at which the wash liquid 30 contacts the pulp mat 26 as a spray 34.

In another exemplary embodiment, the method may further comprise adjusting the shower pipe to achieve an optimal angle at which wash liquid contacts the pulp mat.

It is to be understood that the present invention is by no means limited to the particular constructions herein disclosed or shown in the drawings, but also comprises any modifications or equivalents within the scope of the claims known in the art. It will be appreciated by those skilled, in the art that the assemblies herein disclosed will find utility with respect to multiple shower pipes used to distribute wash liquid.

We claim:

1. A shower pipe assembly to provide a wash liquid for washing a pulp mat, the assembly comprising:
a shower pipe with areas defining oblong orifice openings extending through the wall of the shower pipe, the wall having an inside and an outside; and
a combination plate paddle configured to be removed and configured to be adjusted along the wall of the shower pipe,
wherein the combination plate paddle comprises a plate and a paddle,
wherein the plate is configured to be attached to the wall of the shower pipe and the paddle is configured to distribute wash liquid exiting the shower pipe oblong orifice openings to the pulp mat, the paddle extending from a lower edge of the plate outward from the surface of the shower pipe,
wherein the plate has areas defining a plate opening as adjacent to and configured to communicate with at least one oblong orifice opening of the shower pipe in an open position, and
the combination plate paddle is slideably engaged to the shower pipe by fastening means.

2. The shower pipe assembly of claim 1, wherein a shape of the plate opening is selected from the group consisting of: a rounded trapezoid, rounded triangle, triangle, trapezoid, circle, oval, and oblong geometric shape.

3. The shower pipe assembly of claim 1, wherein the plate is asymmetrical with respect to a center line of the combination plate paddle.

4. The shower pipe assembly of claim 3, wherein the plate slide along the outer wall of the shower pipe to positions over the oblong opening in the pipe.

5. The shower pipe assembly of claim 1, wherein the plate is shaped to fit securely to the outer surface of the shower pipe.

6. The shower pipe assembly of claim 3, wherein a combination bolt plate paddle is provided for each shower pipe orifice opening.

7. The shower pipe assembly of claim 1, wherein the orifice openings extend the length of the shower pipe and are positioned in one or more parallel rows where adjacent orifice openings are staggered such that the orifice openings do not align circumferentially and are located in different rows.

8. The shower pipe assembly of claim 1, wherein shape of the plate opening of the plate is a rounded triangle shape oriented such that a narrow side of the rounded triangle shape is closer to the lower edge of the plate than the upper edge of the plate.

9. The shower pipe assembly of claim 8, wherein the plate has at least one slotted opening and at least one bolt configured to secure the combination plate paddle to the outside shower wall.

10. The shower pipe assembly of claim 9, wherein the at least one slotted opening is configured to allow the combination plate paddle to slide tangentially along an outside diameter of the shower pipe.

11. The shower pipe assembly of claim 9, wherein the at least one slotted opening is configured to allow the combination plate paddle to slide circumferentially along a circumferential arc on the outside wall of the shower pipe.

12. The shower pipe assembly of claim 1, wherein the at least one slotted opening is configured to allow the combination plate paddle to slide horizontally along a length of the outside wall of the shower pipe.

13. The shower pipe assembly of claim 1, wherein shape of the plate opening of the plate is a rounded triangle shape oriented such that a narrow side of the rounded triangle shape is closer to the upper edge of the plate than the upper edge of the plate.

14. A method to adjust the open space of a shower pipe assembly comprising:
having a shower pipe having and inner and outer surface and having areas defining oblong orifice openings positioned along a length of the pipe in at least one parallel row to allow the flow of wash liquid from the shower pipe out of the orifice openings for washing of a pulp mat;
attaching a plate and paddle to the outer surface of the shower pipe, the plate and paddle configured to be removed;
wherein, the plate has areas defining a rounded triangular opening disposed adjacent to each oblong orifice opening of the shower pipe; and
sliding the plate circumferentially along the outer surface of the shower pipe such that an open area defined by the adjacent plate opening and each oblong orifice opening and having a size and a shape, is configured to be adjusted in size and shape;
wherein, the plate having at least one slotted opening further comprises at least one bolt passing through the at least one slotted opening to secure the plate to the shower pipe.

15. The method of claim 14, wherein the plate and paddle are a single combination bolt plate paddle structure.

16. The method of claim 14, wherein by adjusting the open space through which wash liquid flows, the volume and intensity of flow of wash liquid from the shower pipe to the pulp mat can be controlled.

17. The method of claim 14, wherein the open area to allow the flow of wash liquid from the shower pipe to the pulp mat is configured to be adjusted.

18. The method of claim 14 further comprising adjusting the shower pipe to achieve an optimal angle at which wash liquid contacts the pulp mat.
